(19) United States
(12) Patent Application Publication
(10) Pub. No.: US 2022/0120557 A1
(43) Pub. Date: Apr. 21, 2022

(54) PASSIVE BODY SCANNING

(71) Applicant: Naked Labs Austria GmbH, Wien (AT)

(72) Inventors: Gerhard Schultes, Wien (AT); Manuel Hofer, Graz (AT); Richard Heye, Sunnyvale, CA (US)

(21) Appl. No.: 17/428,081

(22) PCT Filed: Feb. 7, 2020
(86) PCT No.: PCT/EP2020/053163

§ 371 Date: Aug. 3, 2021

(30) Foreign Application Priority Data
Feb. 9, 2019 (AT) A 60030/2019

(51) Int. Cl. G01B 11/24; H04N 13/257; H04N 13/296; G06V 40/10

(52) U.S. Cl. CPC G01B 11/24; G06V 40/10; H04N 13/296; H04N 13/257

(57) ABSTRACT

A 3D body scanner for generating 3D body models includes a depth sensor for acquiring depth data of a field of view and a control unit that controls the 3D body scanner and processes the depth data. The control unit can extract body characteristics of a person from the acquired depth data and can compare the extracted body characteristics of the person with body characteristics of already registered users and activate the processing and recording of the depth data from the depth sensor when the comparison determines that the person is a registered user.

### CROSS REFERENCE TO RELATED APPLICATIONS

The present application claims priority to application Serial No. PCT/EP2020/053163 filed Feb. 7, 2020, which is hereby incorporated herein in its entirety by this reference for all purposes.

### FIELD OF THE INVENTION

The invention concerns a 3D body scanner for generating 3D body models comprising: a depth sensor for acquiring depth data of a field of view, a control unit for controlling the 3D body scanner and for processing the depth data.

### BACKGROUND OF THE INVENTION

Today 3D human body models are demanded by various fields of applications that include: Fitness and body styling applications, medical applications, cloth manufacturing industry, cloth internet and retail shops and/or automotive industry.

To generate 3D human body models, 3D body scanners are used.

3D body scanners capture 3D body information by measuring the body dimensions as the body rotates on a turntable at a defined distance from a scanner.

A common disadvantage of the conventional solutions is the need of a costly turntable to rotate the body. The technology needed therefore is a semi-rigid body reconstruction allowing the body only a very limited freedom in motion as it is necessary to keep balance, breath and heartbeat. Recent developments do no longer require a turntable and let the person by the person's own motion turn around at a roughly defined speed but in a defined distance from the scanner. The technology needed therefore is a non-rigid body reconstruction allowing the body some limited freedom in motion. The result of the 3D scan with an application specific interpretation is usually with some delay available on a built-in screen, or a connected mobile device as a smartphone, tablet or laptop. In any case the 3D body scanners need to be installed in a proper way accurately fulfilling conditions of height and angle of equipment installation which might be problematic for a non-skilled user.

Both methods require the user to undergo some periodically inconvenient interaction with the scanner, which are for example: dress with appropriate tight clothing and most likely change clothes afterwards, bring the turntable of the body scanner manually in an appropriate position, step in an appropriate position in front of the body scanner, start the scan procedure, keep for some time a steady state position on the turntable and turn its body around in a defined way in front of the body scanner.

### OBJECTS AND SUMMARY OF THE INVENTION

An object of the invention deals with reducing the inconvenience of the user in periodic scanning but keeping the performance of 3D body model as recorded with conventional approaches. The invented 3D scanner allows in an advantageous way to create and/or update 3D body models of users from their every day activities in range of the scanner in a passive way, without user controlled activation of the scanner or special behavior of the user.

A 3D body scanner is proposed for generating 3D body models. The 3D body scanner comprises a depth sensor for acquiring depth data of a field of view. The field of view is the area, which can be scanned by the depth sensor. The field of view can be described as the scanning area of the depth sensor. The 3D body scanner comprises furthermore a control unit for controlling the 3D body scanner and/or for processing the depth data. The control unit is designed in such a way that it can extract body characteristics of a person moving somehow around in the field of view from at least the acquired depth data, wherein the control unit is designed in such a way that it can compare the extracted body characteristics of the person moving somehow around in the field of view with body characteristics of one or more already registered users. The body characteristics will be used to identify the person in the field of view. For example, the body height of the person will be used to identify the person. Furthermore, the control unit is designed in such a way that it can activate the processing and/or the recording of at least the depth data from the depth sensor, when the comparison is that the person in the field of view is an already registered user. This can also mean that at least the depth data of a non-registered person will not be processed and/or recorded. Therefore, only data of a registered person will be processed and/or recorded. Therefore, the 3D body scanner can be described as a passive 3D body scanner, because no user interaction is needed to operate the 3D body scanner.

In an advantageous embodiment, the 3D body scanner comprises a color camera, in particular a RGB camera and/or a duty cycled low-resolution camera, for acquiring color image data of the field of view, wherein the color camera is connected to the control unit. The color camera can be a RGB camera working as a duty cycled low-resolution camera. For example, the field of view of the depth sensor and the field of view of the color camera is the same. Therefore, the depth sensor and the color camera can scan the same scanning area. The field of view of the depth sensor and the field of view of the color camera overlap at least partially. Furthermore, the control unit is in particular designed in such a way that it can activate the processing and/or the recording of at least the color image data of the field of view by the color camera when the person in the field of view is an already registered user. The field of view of the color camera can be described also as the scanning area.

In an advantageous embodiment, the 3D body scanner comprises a proximity detector for detection of an approach of a person to the 3D body scanner, wherein the proximity detector is connected to the control unit. The control unit is designed in such a way that it can activate the acquiring of the depth data in the field of view by the depth sensor and/or the acquiring of at least the color data in the field of view by the color camera when the person is detected by the proximity detector. Therefore, the 3D body scanner can be started automatically. Therefore, the activation of the user is not necessary.

In an advantageous embodiment, the proximity detector is arranged in such a way that it can detect the approach and/or the presence of the person in the field of view and/or the scanning area. For example, the proximity detector is arranged beside the depth sensor and/or the color camera.

In an advantageous embodiment, the depth sensor is a single or a plurality of active or passive stereo vision, structured light, time of flight and/or Lidar based devices.

In an advantageous embodiment, the proximity detector is a low-power passive infrared detector, a microwave radar, one or more single ray Lidar and/or a duty cycled low resolution camera for image difference recognition.

In an advantageous embodiment, the 3D body scanner comprises a user interface, wherein the user interface is in particular a screen, a touchscreen and/or a keyboard.

In an advantageous embodiment, the 3D body scanner comprises a wireless interface for connecting the 3D body scanner with a mobile device, wherein the mobile device is in particular a smartphone, a tablet, a laptop and/or the user interface. The 3D body scanner can also comprise the mobile device.

Furthermore, a method for operating a 3D body scanner for generating 3D body models is proposed. The 3D body scanner can be designed according to one or more features according to the previous and/or the following description. Furthermore, the 3D body scanner of the previous and/or the following description can be designed in such a way that the 3D body scanner can perform the method for operating according to the previous and/or the following description.

The method comprises the step that a depth sensor acquires depth data of a field of view. The field of view can also be described as a scanning area. A control unit controls the 3D body scanner and/or processes the depth data. At a further step, the control unit extracts body characteristics of a person moving somehow around in the field of view from at least the depth data, wherein the control unit compares the extracted body characteristics of the person in the field of view with body characteristics of one or more already registered users. The control unit activates the processing and/or recording of at least the depth data from the depth sensor, when the comparison is that the person in the field of view is an already registered user.

In an advantageous embodiment, the 3D body scanner comprises a color camera for acquiring color image data of the field of view, wherein the color camera is connected to the control unit. The control unit can be designed in such a way that it activates the processing and/or the recording of the color image data of the field of view by the color camera when the comparison is that the person in the field of view is an already registered user.

In an advantageous embodiment, the 3D body scanner comprises a proximity detector for detection an approach of a person to the 3D body scanner, wherein the proximity detector is connected to the control unit. Furthermore, the control unit activates the acquiring of at least the depth data in the field of view by the depth sensor and/or the acquiring of the color image data by the color camera when the person is detected by the proximity detector.

In an advantageous embodiment, an user proceeds a registration procedure, wherein the 3D body scanner, in particular the control unit, extracts from the depth data and/or color image data captured during the registration procedure body characteristics, in particular body height, body shape, characteristics of motion, skin and/or eye color, skin texture and/or biometric data of the face. Therefore, after registration, the 3D body scanner, in particular the control unit, can recognize the already registered user or person by the body characteristics.

In an advantageous embodiment, the control unit analyzes the depth data and/or the color image data to identify whether the person in the scanning area is a registered or a non-registered user. This can happen by analyzing the depth data and/or the color image and by comparing this with the body characteristics of the user. Furthermore, the control unit generates the 3D body model only if the person in the scanning area is an already registered user and/or wherein the control unit ignores the depth data and/or the color image data if the person is a non-registered user.

In an advantageous embodiment, control unit deactivates the depth sensor and/or a color camera after a predetermined time after the proximity detector no longer detects a person. For example, the predetermined time might be 5 or 10 minutes. The deactivation of the 3D body scanner, in particular the depth sensor and/or a color camera, can save energy.

In an advantageous embodiment, the control unit determines of the person a body height, a body mass, a body shape, characteristics of motion, a skin and/or an eye color, a skin texture and/or bio-metric data of the face from the depth data and/or color image data. This determination can help to create the body characteristics and/or to create the 3D body model.

In an advantageous embodiment, the control unit identifies usable body regions and/or unusable body regions from the depth data and/or color image data.

In an advantageous embodiment, the control unit composes the 3D body model from several usable body regions. It can happen that the person to be scanned is not fully visible and/or has unusable body regions. Nevertheless, the captured depth data and/or color images can contain usable body regions. The control unit can compose the 3D body model from several depth data and/or color images, which contain several different usable body regions. For example, the control unit can compose the legs of a person of a first scan with the torso or upper body of a second scan. The head can be contained, for example, in a third scan.

In an advantageous embodiment, the control unit determines changes of the 3D body model of a person over time. Therefore, for example a progress of a fitness training can be determined.

### BRIEF DESCRIPTION OF THE DRAWINGS OF EXEMPLARY EMBODIMENTS

Additional advantages of the invention are described in the following exemplary embodiments. The drawings show in:

FIG. 1 a 3D body scanner scanning a scanning area,

FIG. 2 a 3D body scanner in more detail and

FIG. 3 a person with usable and unusable body regions.

### DETAILED DESCRIPTION OF EXEMPLARY EMBODIMENTS

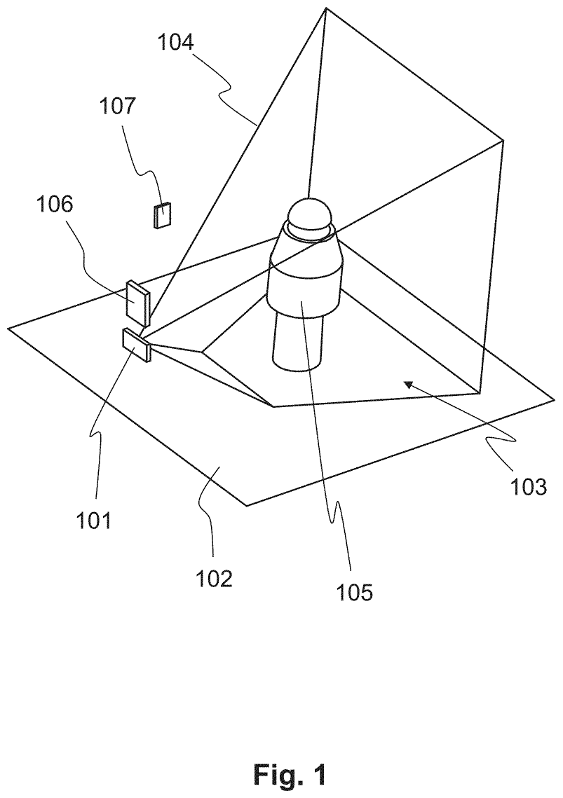

The passive 3D scanner 101 with a depth sensor 109 and optional color camera 112, in particular a RGB camera. As schematically shown in FIG. 1, the scanner 101 is in an advantageous way placed on a wall or a piece of furniture so that the scanner 101 can be “looking” in a region where the users 105 to be scanned are frequently present and have various activities. It is advantageous that the scanning area on the floor 103 is freely accessible and that neither the field of view (FOV) of the depth sensor 109 nor the FOV of the optional RGB camera is blocked by obstades. The connected optional user interface 106 may contain, for example, but not limited to, a screen, a touchscreen and a keyboard, which can be placed in a convenient position for the user. The included depth sensor 109 may be, but not limited to, a single (or a plurality of) active or passive stereo vision, structured light, time of flight and/or Lidar based devices.

All users 105 to be scanned can be registered to the passive scanner 101 in order that the scanner 101 can later on assign the scanned data (depth maps) to the correct body model. Therefore, the user 105 can at a first step identify itself using the connected mobile device 107 which is, for example, but not limited to, a smartphone, a tablet, or a laptop, or the optional user interface. At a second step the user 105 can do some training walks and motions in appropriate tight clothing within the scanning area on the floor 103. To ensure fast registration success it is recommended that the user 105 is fully visible and is wearing appropriate tight clothes to show an accurate body shape. During this phase the passive 3D scanner 101 extracts body characteristics that include, but not limited to, a body height, a body shape, characteristics of motion, a skin and/or eye color, a skin texture and/or a bio-metric data of the face on depth map and optionally RGB level to be able to unequivocally identify a registered user 105. When the passive 3D scanner 101 has acquired sufficient user characteristics, the scanner 101 notifies the user 105 by the mobile device 107 and/or the optional user interface 106 that the training process is finished. This procedure can happen multiple times to register different users 105. After this training process the passive 3D scanner 101 is ready for its, seen from user perspective, “passive” operation.

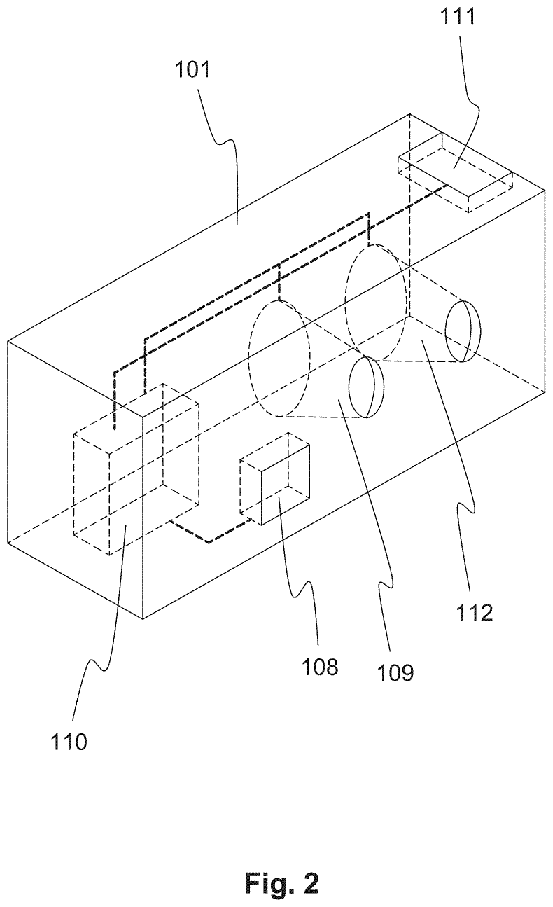

When the passive 3D scanner 101 is in sleep mode to save energy and a person 105 is approaching the field of view (FOV) of the depth sensor 109 and the optional RGB camera, then the passive 3D scanner 101 in an advantageous way automatically detects the person or user 105 by its built in proximity detector 108, which is schematically shown in FIG. 2 for example, and activates the scanner 101. It is advantageous that no direct user interaction is therefore required. In an advantageous way the proximity detector 108 will be, for example, but not limited to, a low-power passive infrared detector a microwave radar, one or more single ray Lidar or a duty cycled low resolution camera for image difference recognition. When the passive 3D scanner 101 is already active and a person 105 or a further person 105 is approaching the field of view (FOV) of the depth sensor 109 and the optional RGB camera, then the passive 3D scanner 101 in an advantageous way automatically detects the person 105 by the appearance of the person 105 on the scanned depth map and optional RGB image.

At first the stream of depth maps and optionally RGB images are in an advantageous way analyzed for user characteristics to automatically identify registered users 105. As done at user registration the passive 3D scanner 101 extracts body characteristics that include, but not limited to, a body height, a body shape, characteristics of motion, skin and/or eye color, skin texture and/or bio-metric data of the face on depth map and/or optionally RGB level to be able to unequivocal identify a registered user 105 by comparing these characteristics with those characteristics obtained at prior registration. If a match is found, the passive scanning (data acquisition) and body model reconstruction process will start. Non-registered users 105 can be ignored.

As noted above, FIG. 2 shows the 3D body scanner in more detail. Features which are already described in the previous figure are not explained again for the sake of simplicity. Furthermore, some features might only be described in subsequent figures. Furthermore, for the sake of simplicity, the same reference signs are used for the same characteristic. Furthermore, for the sake of clarity, not all characteristics can be shown in the following figures. However, characteristics shown in one or more of the preceding figures may also be present in one or more of the following figures. Furthermore, for the sake of clarity, characteristics may also be shown in one or more of the following figures. Nevertheless, features that are only shown in one or more of the following figures may also be present in a previous figure.

The 3D body scanner 101 comprises the depth sensor 109 for acquiring depth data of a field of view 104. Additionally or alternatively the 3D body scanner 101 comprises a color camera 112, in particular a RGB camera, for acquiring color image data of the field of view 104. The depth sensor 109 and the color camera 112 are connected to a control unit 110. The control unit 110 can control the 3D body scanner 101 and/or can process the data captured by the depth sensor 109 and/or the color camera 112.

Furthermore, FIG. 2 shows the proximity detector 108, which is arranged in such a way that the proximity detector 108 can detect an approach of the person 105 in the field of view 104, which is schematically shown in FIG. 1. The proximity detector 108 is also connected to the control unit 110 as schematically indicated by the dashed line in bold typeface. Therefore, the control unit 110 can activate the depth sensor 109 and/or the color camera 112 if the person approaches the field of view 104. As shown in FIG. 2, the depth sensor 109 and/or the color camera 112 are arranged beside the proximity detector 108. Therefore, the depth sensor 109 and/or the color camera 112 and the proximity detector 108 can scan the scanning area and/or the field of view 104.

The 3D body scanner 101 can comprise furthermore a wireless interface 111 schematically shown in FIG. 2 for connecting the 3D body scanner 101 with the mobile device 107, which is schematically shown in FIG. 1.

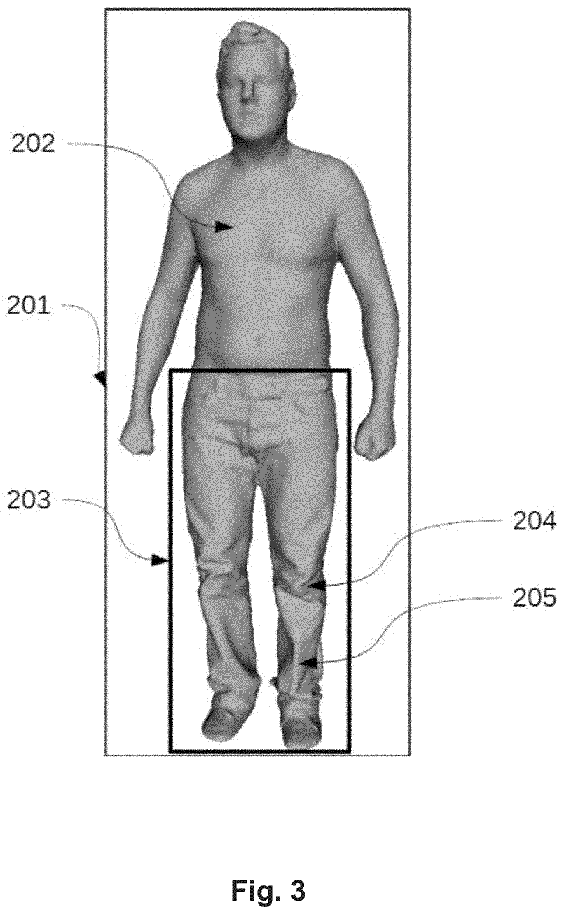

FIG. 3 shows an example of a person with usable body regions 202 and unusable body regions 203. Features which are already described in the previous figure are not explained again for the sake of simplicity. Furthermore, features can only be described in subsequent figures. Furthermore, for the sake of simplicity, the same reference signs are used for the same characteristic. Furthermore, for the sake of clarity, not all characteristics can be shown in the following figures. However, characteristics shown in one or more of the preceding figures may also be present in one or more of the following figures. Furthermore, for the sake of clarity, characteristics may also be shown in one or more of the following figures. Nevertheless, features that are only shown in one or more of the following figures may also be present in a previous figure.

The passive 3D scanner 101 collects in an advantageous way a large number of depth maps and optionally RGB images of the user from different distances, different directions, at different motions and/or different body poses. It may happen that the user is not fully visible because he is shaded by obstacles or is wearing at least partially not appropriate tight clothes to show an accurate body shape. This would normally lead to a not converging or not accurate body reconstruction. To combat this problem, the invented 3D body scanner 101 identifies in an advantageous way usable body regions 202 which are uncovered or only covered by appropriate tight clothing and unusable body regions 203 which are covered or hidden by too wide clothing by body surface analysis of the depth maps and optional RGB image data. The body surface analysis identifies by, for example, but not limited to, wrinkles 204, regions that do not conform to the natural human body shape and regions that are too different from a standard and/or previously stored body model to distinguish between usable and not usable regions. Also, regions that are deemed too small to be usable regions may be rejected from further processing. The data collection process to establish and/or update a 3D body model can last over several cycles of user activity in the scan area.

In the invented solution the captured depth map data of the good or usable regions 202 is in an advantageous way processed by a so called “fully non-rigid 3D body reconstruction” algorithm. This is mathematically using a segmented body model with rigid limbs (bones), anatomically correctly movable joints and elastic tissue and skin modeling to create or update an accurate 3D body model of a registered user. The captured data will be fitted to the body model by allowing only anatomically correct motions and deformations. The mathematical calculations will be performed advantageously in parallel to data capturing so that the progress of reconstruction is short term in the present. The time required for data acquisition to newly create or to update a body model depends on the number and quality of scanned poses in field of view (FOV) 104 of the depth sensor 109 associated with the frequency of activity of a user. The user gets a related message from the connected mobile device or the optional user interface if the scanner 101 cannot create and/or update a body model in a defined amount of time or captured depth maps by the reason of any of the following circumstances: missing user activity and/or non-visibility of a part of the body caused by only monotonic (repetitive) movements in the scan area and/or permanently wearing non-appropriate wide clothing and/or too strong ambient light and/or blocking of the passive scanner's FOV by obstacles.

When a body model has been successfully established or updated, then the user 105 gets a notification on the connected mobile device 107 or optional user interface 106. Then the user can review the body model with an application dependent interpretation on the connected mobile device 107 or optional user interface 106.

An advantageous embodiment of the invention is that the passive 3D scanner 101 reconstructs in an advantageous way 3D body models from one or more different users 105 by scanning the users 105 in various body poses at every day activities within the scanning area 103 or field of view 104 of the passive 3D scanner 101.

An advantageous embodiment of the invention is that the invented passive 3D scanner 101 does not need to be installed under precise, complicated geometrical conditions, but instead can in an advantageous way be mounted on a wall or placed somewhere on a piece of furniture just “looking” in an area where the users 105 to be scanned are frequently present and have various activities.

An advantageous embodiment of the invention is that all users 105 have to be registered so that the scanned data (depth maps) can be assigned the correct body model, whereas the users 105 have at first to identify by using the connected mobile device 107 or the optional user interface 106 then the users have to do some training walks and motions in appropriate tight clothing within the scanning area on the floor 103 to allow the passive 3D scanner 101 to extract body characteristics that include, but are not limited to: body height, body shape, characteristics of motion, skin- and eye color, skin texture and/or bio-metric data of the face on depth map and optionally RGB level to be able to later unequivocally identify a registered user 105.

An advantageous embodiment of the invention is that the invented passive 3D scanner 101 is in an advantageous way normally in sleep mode to save energy until a person 105 is approaching the field of view 104 of the depth sensor 109 and the optional color camera 112, in particular the RGB camera, the passive 3D scanner 101 automatically detects the person 105 by a proximity detector 108 and activates the scanner 101, whereas no direct user 105 interaction is therefore required.

An advantageous embodiment of the invention is that the proximity detector 108 will be in an advantageous way, for example, but not limited to, a low-power passive infrared detector, a microwave radar, one or more low cost single ray Lidars or a duty cycled low resolution camera for image difference recognition.

An advantageous embodiment of the invention arises from the following attribute. If the passive 3D scanner 101 is already active and a person 105 or a further person 105 is approaching the field of view 104 of the depth sensor 109 and the optional RGB camera, then the passive 3D scanner 101 in an advantageous way automatically detects the person 105 by its appearance on the captured depth map and/or optional RGB image.

An advantageous embodiment of the invention is that to unequivocally identify a registered user 105, the stream of depth maps and optionally RGB images are in an advantageous way analyzed for user characteristics that are, but not limited to, body height, body shape, characteristics of motion, skin and/or eye color, skin texture and/or bio-metric data of the face, and that the extracted user characteristics are compared with that of the prior stored registration data.

An advantageous embodiment of the invention is that the invented 3D body scanner 101 uses body surface analysis of the depth maps and optional RGB image data to identify in an advantageous way (i) usable body regions 202 which are uncovered or only covered by appropriate tight clothing and (ii) unusable body regions 203 which are covered or hidden by too wide clothing.

An advantageous embodiment of the invention is that the body surface analysis identifies, for example, but not limited to, wrinkles 204, not the natural human body shape conform regions 205, which are too different from a standard or previously stored body model to distinguish between usable and not usable regions, and that too small good regions also may be rejected from further processing.

An advantageous embodiment of the invention is that the data collection process to establish and/or update a 3D body model can last over several cycles of user activity in the scanning area on the floor 103 and 3D body models are updated any time when new scan data is available.

An advantageous embodiment of the invention is that the body model reconstruction is performed by a so called “fully non-rigid body reconstruction” algorithm which is in an advantageous way mathematically using a segmented body model with rigid bones of the limbs, anatomic correctly movable joints and elastic tissue and skin modeling to create or update an accurate 3D body model of a registered user and the processing will be performed advantageously in parallel to data capturing so that the progress of reconstruction is short term in real time.

The invention is a passive 3D body scanner 101 which reconstructs in an advantageous way 3D body models from one or more different users 105 by scanning the users 105 in various body poses at every day activities within the scanning range of the passive 3D scanner 101. The scanner 101 is activated by the proximity of a person 105 and starts the scan when that person 105 is within a specified scanning range. A user's body characteristics profile is used to ensure the data is assigned correctly to a registered user 105. The passive scanner 101 collects 3D body depth maps from different directions and poses and then calculates a 3D body model using a so called fully non-rigid reconstruction algorithm. The time required for data acquisition depends on the number of scanned poses in range of the 3D body scanner 101 associated with the activity of a user 105.

The invention is not limited to the embodiments shown or described. Rather, any and all combinations of the individual features described, as shown in the figures or described in the description, and to the extent that a corresponding combination appears possible and sensible, are subject matters of the invention.

### LIST OF REFERENCE CHARACTERS

101 3D body scanner

102 floor

103 scanning area

104 field of view

105 person or user

106 user interface

107 mobile device

108 proximity detector

109 depth sensor

110 control unit

111 wireless interface

112 color camera

202 usable body region

203 unusable body region

204 wrinkles

205 not body shape conform region

1. 3D body scanner for generating 3D body models comprising:
a depth sensor for acquiring depth data of a field of view,
a control unit configured for controlling the 3D body scanner and for processing the depth data, and
a storage unit in which are stored body characteristics of one or more already registered users;
wherein the control unit is designed in such a way that it can extract body characteristics of a person moving somehow around in the field of view from the depth data,
wherein the control unit is designed in such a way that it can compare the extracted body characteristics of the person moving somehow around in the field of view with the body characteristics of one or more already registered users and
wherein the control unit is designed in such a way that it can activate the processing and/or the recording of at least the depth data from the depth sensor, when the comparison of the control unit determines that the person in the field of view is an already registered user.

2. 3D body scanner according to claim 1 further comprising a color camera configured for acquiring color image data of the field of view and connected to the control unit; and
wherein the control unit (110) is configured for activating the processing and/or the recording of at least the color image data of the field of view by the color camera when the person in the field of view is determined by the control unit to be an already registered user.

3. 3D body scanner according to claim 2, further comprising a proximity detector configured for detection of an approach of a person to the proximity detector and connected to the control unit and
wherein the control unit is configured for activating the acquiring of the depth data in the field of view by the depth sensor and/or the acquiring of at least the color data in the field of view by the color camera when the person is detected by the proximity detector.

4. 3D body scanner according to claim 3, wherein the proximity detector is configured for detecting the approach and/or the presence of the person in the field of view, wherein the proximity detector is arranged beside the depth sensor and/or the color camera.

5. 3D body scanner according to claim 3, further comprising a user interface connected to the control unit;
wherein the depth sensor is a single or a plurality of active or passive stereo vision, structured light, time of flight and/or Lidar based devices and/or
wherein the proximity detector (108) is a low-power passive infrared detector, a microwave radar, one or more single ray Lidar or a duty cycled low-resolution camera for image difference recognition and/or
wherein the user interface includes a screen, a touchscreen and/or a keyboard.

6. 3D body scanner according to claim 1, further comprising a wireless interface connected to the control unit and configured for connecting the control unit with a mobile device that is selected from the list of a smartphone, a tablet, and a laptop.

7. Method for operating a 3D body scanner for generating 3D body models, wherein the method comprises the following steps:
a depth sensor acquires depth data of a field of view,
a control unit that has a storage unit containing body characteristics of one or more already registered users controls the 3D body scanner and processes the depth data,
wherein the control unit extracts body characteristics of a person moving somehow around in the field of view from at least the depth data,
wherein the control unit performs a comparison of the extracted body characteristics of the person in the field of view with the body characteristics of one or more already registered users contained in the storage unit, and
wherein the control unit activates the processing and/or recording of at least the depth data from the depth sensor, when the comparison determines that the person in the field of view is an already registered user.

8. Method for operating a 3D body scanner according to claim 7, wherein the 3D body scanner comprises a color camera for acquiring color image data of the field of view wherein the color camera is connected to the control unit and wherein the control unit activates the processing and/or the recording of the color image data of the field of view by the color camera when the comparison determines that the person in the field of view is an already registered user contained in the storage unit.

9. Method for operating a 3D body scanner according to claim 7, wherein the 3D body scanner comprises a proximity detector connected to the control unit and configured for detection an approach of a person to the 3D body scanner and wherein the control unit activates the acquiring of at least the depth data in the field of view by the depth sensor and/or the acquiring of the color image data by the color camera when the person is detected by the proximity detector.

10. Method for operating a 3D body scanner according claim 7, further comprising the steps of registering a user during a registration procedure, wherein the control unit extracts from the depth data and/or color image data captured during the registration procedure one or more of the body characteristics selected from the following list: body height, body shape, characteristics of motion, skin and/or eye color, skin texture and/or bio-metric data of the face.

11. Method for operating a 3D body scanner according to claim 8, wherein the control unit deactivates the depth sensor and/or the color camera after a predetermined time after the depth sensor and/or the color camera no longer detects a person.

12. Method for operating a 3D body scanner according to claim 7, wherein the control unit determines of the person in the field of view, a body height, a body mass, a body shape, characteristics of motion, a skin and/or an eye color, a skin texture and/or bio-metric data of the face from the depth data and/or color image data.

13. Method for operating a 3D body scanner according to claim 8, wherein the control unit identifies usable body regions from the depth data and/or color image data.

14. Method for operating a 3D body scanner according to claim 13, wherein the control unit composes a 3D body model from several usable body regions.

15. Method for operating a 3D body scanner according to claim 14, wherein the control unit determines changes of the 3D body model of the person over time.

16. 3D body scanner according to claim 2, wherein the color camera is a RGB camera.

17. 3D body scanner according to claim 2, wherein the color camera is a duty cycled low-resolution camera.

18. 3D body scanner according to claim 5, further comprising a wireless interface connected to the control unit and configured for connecting the control unit with the user interface.

19. Method for operating a 3D body scanner according to claim 9, wherein the control unit deactivates the depth sensor and/or the proximity detector after a predetermined time after the proximity detector and/or the depth sensor no longer detects a person.

20. Method for operating a 3D body scanner according to claim 8, wherein the control unit identifies unusable body from the depth data and/or color image data.
